(19) United States
(12) Patent Application Publication
(10) Pub. No.: US 2005/0170047 A1
(43) Pub. Date: Aug. 4, 2005

(54) Nutritionally enriched maple syrup

(75) Inventors: Yoshiko Watanabe, Osaka-shi (JP); Luc Bergeron, Vancouver (CA); Toshihiro Ishiguro, Toyono-gun (JP)

Correspondence Address: RABIN & Berdo, PC, 1101 14TH STREET, NW, SUITE 500, WASHINGTON, DC, 20005, US

(73) Assignees: MIC CO., LTD., Osaka 545-0043 (JP); L.B. MAPLE TREAT INC., British Columbia V6J 1P1 (CA)

(21) Appl. No.: 10/505,552

(22) PCT Filed: Feb. 21, 2003
(86) PCT No.: PCT/JP03/01894

(30) Foreign Application Priority Data
Feb. 25, 2002 (JP) 2002-48346

(51) Int. Cl. A23L 1/30

(52) U.S. Cl. 426/72

(57) ABSTRACT

The present invention relates to nutritionally enriched maple syrup, which is enriched in vitamins, and more particularly to nutritionally enriched maple syrup which contains vitamin C in an amount of 50 mg or more based on 100 ml of maple syrup obtained by thermally concentrating a maple sap. The present invention also includes maple syrup enriched in vitamins such as vitamin E and vitamin B₁ and other nutrients. According to the present invention, the nutritional value and quality of maple syrup, particularly maple syrup obtained by thermal concentration, can be improved and the range of its use for other foods can be widened. Nutrient enrichment can be carried out by an efficient method suited for industrial scale production. Moreover, the nutritionally enriched maple syrup of the present invention exhibits a well-balanced flavor, and thus it can be widely added to various foods.

### TECHNICAL FIELD

The present invention relates to nutritionally enriched maple syrup, which is enriched in vitamins such as vitamin C, vitamin E and vitamin B₁.

### BACKGROUND ART

Maple syrup is made from the sap of maple trees belonging to Aceraceae that grow in the region of the North American continent ranging from the Canadian province of Quebec to the state of Ohio in the U.S.A. The sap is processed in an evaporator to remove some 90% of water content so as to obtain the maple syrup as the remainder. This manufacturing method has been maintained over one hundred years, with the product patronized as 100% pure high quality sweetener. The traditional concentration method has been adhered to by the indigenous producers, while the consumers love the natural sweet taste.

However, the traditional method of producing maple syrup has a problem in that some of the intrinsic components of the maple sap are thermally decomposed or lost during thermal concentration. Therefore, the maple syrup has been used mainly as a sweetener containing thermally stable sugar and other components. Concentration at a high temperature alters the color (conventional maple syrup has a pale brown color).

Meanwhile it is important to take sufficient amounts of essential nutrients in daily diet for the purpose of health care. But recently increasing numbers of people, particularly of the younger generation, tend to live on quick and light meals such as fast foods, giving rise to a concern about balanced intake of nourishment. To counter this problem, nutrition supplements have been commercialized but these products often take the form of tablets or capsules which cannot be regarded as foods. Thus the nutrition supplements can provide nutrients but lack proper flavor of food and cannot be relied on as a nutritional source on a daily basis.

Among nutrients, vitamins are essential ones that must be taken every day but tend to be deficient in meals which are prevalent today. Thus there are strong needs to take sufficient amounts of vitamins through natural foods. However, it is difficult to add required amounts of vitamins to a food in stable condition without compromising the flavor of the food. Vitamin C, for example, has a strong sourness and many people do not like to take it in such a form as tablets due to the sourness. Beverages enriched in vitamin C are commercialized, but the content of vitamin C is limited for the reason of flavor and other considerations.

Thus, an object of the present invention is to provide a maple syrup product, which contains nutrients that conventional maple syrup lacks, and is enriched in vitamins which tend to be deficient in meals that are prevalent today, and also has good flavor.

### DISCLOSURE OF THE INVENTION

Under these circumstances, the present inventors have tried adding vitamins to various foods, but have not solved the problems of taste and quality. Also the present inventors have studied the Production methods of maple syrup and had the idea of adding vitamins to the maple syrup and thus a trial of the addition of vitamins was made. As a result, more surprisingly, the present inventors have obtained such a finding that refreshing light sweetness and sourness are exhibited and also the odd taste and scorch odor specific to conventional maple syrup are eliminated and the flavor is remarkably improved by adding vitamin C to the maple syrup. This result was unexpected and thus the present inventors have succeeded in the development of a maple syrup with a new flavor which has never been achieved.

The present invention provides “nutritionally enriched maple syrup, which is enriched in vitamins”. In the present invention, nutritionally enriched maple syrup which contains vitamin C in an amount of 50 mg or more based on 100 ml of maple syrup is included.

As used herein, the term “enriched in vitamins” means to add vitamins in an amount higher than that of vitamin contained in a maple sap or maple syrup obtained therefrom, enrich vitamins lost during the manufacturing process, or add vitamins which are not contained in the maple sap.

### MODE FOR CARRYING OUT THE INVENTION

In the present invention, the maple syrup is to be enriched with vitamins. Maple syrup has a sugar content degree of about 8 to 70 Brix, preferably 20 to 65 Brix, and more preferably 30 to 60 Brix, which is obtained by concentration of a maple sap having a sugar content of about 1.5 to 4 Brix and at neutral pH. The concentration method is not specifically limited and any commercially available maple syrup is obtained by charging a maple sap in an evaporator and thermally concentrating it for a long time. The conditions of thermal concentration vary depending on the kind of the evaporator and examples of the concentration method include a method of thermally evaporating under atmospheric pressure at 100° C. and a method of concentrating at 30 to 90° C. using a concentration apparatus equipped with a pressure reducing device. When the concentration temperature is decreased, excess decomposition of the component is suppressed but the concentration efficiency is lowered. In the present invention, the effect of improving quality is also exerted on maple syrup obtained by thermal concentration at 100° C. However, it is preferable to use, as a raw material, maple syrup obtained by thermal concentration under reduced pressure at 50 to 90° C., and preferably 55 to 80° C., in view of quality and industrial scale production.

By this thermal concentration method, although thermally unstable vitamins such as vitamin C are thermally decomposed, thermally stable saccharides are concentrated and the resulting maple syrup exhibits natural light sweetness free from odd taste. In the present invention, the maple syrup obtained by thermal concentration as the object is supplemented with vitamins, which were lost during thermal concentration, or is enriched in a high content of vitamins.

Vitamins to be added in a higher amount in the present invention include vitamin C as an essential component, and also include one or more kinds of vitamins selected from among vitamin E, vitamin B₁ and niacin. The amount of vitamins is preferably 50 mg or more based on 100 ml of the maple syrup in case of vitamin C, and the upper limit is not specifically limited but is 5000 mg or less. It is preferable that the maple syrup contains vitamin E in an amount of about 3 to 150 mg and vitamin B₁ in an amount of 5 to 15 mg, based on 100 ml of the maple syrup.

As described in the manual of Japanese Pharmacopoeia (1991), the required intake of vitamin C is from 50 to 200 mg per day, and lack of vitamin C causes scurvy, Möller-Barlow disease, increase in bleeding tendency and growth retardation, thus lowering ability capable of producing antibody and ability capable of healing wound. Also it is reported that vitamin C exerts effects such as participation in the production of collagen, enhancement in resistance to blood capillaries, improvement in bleeding tendency, participation in function of adrenal cortex (prevention of stress reaction) and suppression of production of melanin pigment in the living body. As described above, it is considered that vitamin C is one of vitamins to which sufficient attention must be paid so as to regularly take it.

In the present invention, other nutrients such as minerals (for example, calcium, magnesium, iron, and iodine) and amino acids (for example, lysine, threonine, triptophan, and methionine) may be added, together with vitamins.

Among the vitamins to be added to the maple syrup, water-soluble vitamins are added in the form of a solid such as educt or edible salt, or added after previously preparing an aqueous solution. In the case of water-insoluble vitamins, it is advantageous to use a method of using an edible water-soluble salt or derivative or a method of adding after previously preparing an emulsion because it is easily miscible with the maple syrup. In case of the addition, it is optionally subjected to heating and stirring. In case of the addition of other nutrients, the same method may be employed.

The maple syrup enriched in vitamins is filled into a container (for example, bottle, paper pack, or PET bottle) to provide a product in a sterilized, cooled or frozen state. It is preferable to use, as the sterilization method, a sterilization method with less heating load, for example, pasteurization and shower sterilization which are applied to conventional liquid foods.

The nutritionally enriched maple syrup, which is enriched in vitamins, of the present invention can be used for the purpose of imparting sweetness similar to conventional maple syrup, and is also used in the form of a beverage or used for the purpose of improvement in quality and nutrient enrichment.

### EXAMPLES

The present invention will now be described in more detail by way of Test Examples and Examples.

### Test Example 1

An aqueous 25% solution was prepared by adding 1 g of vitamin C to 4 ml of water, followed by heating to 40° C. 0 to 32 ml (see Table 1) of maple syrup (Canadian No. 1 Medium, manufactured by L.B. Maple Treat Inc., sugar content degree: 50 Brix, vitamin C content: 0%) was added to 1 ml of the resulting aqueous solution, and then taste, pH and color were examined. The results are shown in Table 1.

### Test Example 2

0 to 8 ml (see Table 1) of honey (distributed by L.B. Maple Treat Inc.) was added to 1 ml of the aqueous vitamin C solution prepared in Test Example 1, and then taste, pH and color were examined. The results are shown in Table 1.

### Test Example 3

0 to 36 ml (see Table 1) of an aqueous saturated solution (15° C.) of sugar (very-refined sugar, manufactured by TAITO Co., Ltd.) was added to 1 ml of the aqueous vitamin C solution prepared in Test Example 1, and then taste, pH and color were examined. The results are shown in Table 1.

TABLE 1

| | Amount (ml) | Taste | pH | Color |
|---|---|---|---|---|
| Test Example 1 | 0 | strong sourness/no mildness | 1 | colorless |
| (Maple syrup) | 2 | strong sourness/sweetness | 1-2 | discoloration of brown color |
| | 4 | sourness/sweetness/mildness | 3-4 | discoloration of brown color |
| | 8 | sweetness/slight sourness | 4-5 | discoloration of brown color |
| | 16 | sweetness/less sourness | 6-7 | discoloration of brown color |
| | 32 | sweetness of maple | 6-7 | discoloration of brown color |
| Test Example 2 | 0 | strong sourness/no mildness | 1 | colorless |
| (Honey syrup) | 2 | strong sourness/sweetness | 1-2 | pale yellow color |
| | 4 | sourness/sweetness/mildness | 4 | pale yellow color |
| | 8 | sweetness/slight sourness | 4-5 | pale yellow color |
| Test Example 3 | 0 | strong sourness/no mildness | 1 | colorless |
| (Sugar syrup) | 2 | strong sourness/sweetness | 1-2 | colorless |
| | 4 | sourness/sweetness | 2 | colorless |
| | 8 | sweetness/sourness | 2-3 | colorless |
| | 16 | Sweetness | 3 | colorless |
| | 32 | Sweetness | 3 | colorless |

Test Examples 1 to 3 were carried out to obtain the following results.

1) When vitamin C is added to maple syrup, a syrup solution having proper sourness and sweetness is obtained. The concentration of vitamin C corresponds to 3.5-0.8 g based on 100 ml of the syrup.

2) In a comparison between sweetness and sourness, when vitamin C was added to maple syrup and honey syrup respectively, a rapid decrease in sourness was recognized at a low concentration and a decrease in sourness was not recognized when the sugar syrup has a high concentration.

3) With regard to taste, maple syrup containing vitamin C added therein was most mild and showed well-balanced taste.

4) In view of ease of preparation, vitamin C can be easily dissolved in maple syrup, whereas, vitamin C is hardly miscible with honey syrup and it is very hard to perform mass production.

5) Raw maple syrup has a pale brown color and discoloration was caused by the addition of vitamin C. This fact is advantageous for improvement in quality of the maple syrup.

### Example 1

1000 g of vitamin C powder was added in 4000 ml of water and then the suspension was heated to 40° C. and stirred at the same temperature thereby to completely dissolve the powder. Under stirring, the resulting aqueous vitamin C solution was added to 50 L of maple syrup (Canadian No. 1 Medium, sugar content: 50 Brix, vitamin C content: 0%) at room temperature to obtain maple syrup enriched uniformly in vitamin C.

### Example 2

A bottle product of vitamin C-containing maple syrup was produced by pasteurizing 54 L (liter) of the vitamin C-containing maple syrup obtained in Example 1 at 60° C. for 10 minutes, immediately charging the pasteurized maple syrup in a syrup supply portion of a sterilized bottling device, automatically dispensing 250 ml each of the maple syrup in a 300 ml sterilized glass bottle, and sealing and fixing the glass bottle.

A bottle product of vitamin C-enriched maple syrup was produced by charging 54 L of the vitamin C-containing maple syrup obtained in Example 1 in a syrup supply portion of a sterilized bottling device, automatically dispensing 250 ml each of the maple syrup in a 300 ml sterilized glass bottle, and contacting the glass bottle with hot water shower at 90° C. for 3 minutes.

### Example 3

A bottle product of maple syrup enriched in vitamins C, E and B₁ was produced by adding 3.0 g of vitamin E and 1.0 g of vitamin B₁ to 54 L of the vitamin C-containing maple syrup obtained in Example 1 under stirring, pasteurizing the maple syrup at 60° C. for 10 minutes, immediately charging the pasteurized maple syrup in a syrup supply portion of a sterilized bottling device, automatically dispensing 250 ml each of the maple syrup in a 300 ml sterilized glass bottle, and sealing and fixing the glass bottle.

### INDUSTRIAL APPLICABILITY

The nutritionally enriched maple syrup of the present invention is a food with very high nutritional value because it can be supplemented with vitamins, which were lost during the manufacturing process, and can be enriched in a high content of vitamins and also can be enriched in vitamins which are not contained in maple sap. The nutritionally enriched maple syrup can be preferably used as a sweetener and used for various foods such as beverages because it is well balanced between refreshing sourness and sweetness.

The maple syrup containing vitamin C added therein of the present invention has no or pale brown color specific to conventional maple syrups and therefore has remarkably improved appearance and quality. The maple syrup is classified into light transmittance grading of Extra Light, Light, Medium Amber, Dark Amber and Dark in order because the level light transmittance varies depending on production area, harvesting time and thermal concentration method of raw materials. The maple syrup with the grading of Extra Light has the best quality and is therefore sold at high price, but its production quantity is limited. According to the present invention, the maple syrup with the grading of Dark can be improved to provide maple syrup with the grading of Light or more desirable grades. In view of taste, the scorch taste specific to raw maple syrup is improved, and thus providing maple syrup with a new taste that has never been achieved.

Intake of the nutritionally enriched maple syrup of the present invention in various edible forms can contribute to health maintenance and health promotion for humans. The maple syrup is easily enriched with vitamins and the method of the present invention is by far suited for industrial scale production as compared with the case of adding vitamins to honey syrup or sugar syrup, and also maple syrup graded at a higher quality can be obtained.

In the present invention, supplement of vitamin C is conducted by continuously taking the nutritionally enriched maple syrup enriched in vitamin C, and thus there can be expected the effects of preventing osteoporosis, beautifying the skin, maintaining polish and firmness of the skin, preventing various disorders from strong stress stimulation, and ensuring a healthy body that helps prevent catching a cold. Since the maple syrup enriched with vitamin C increases the light transmittancy of the maple syrup, the maple syrup can be applied to other foods and, moreover, it is expected that an antioxidative effect (prevention of deterioration of quality) is exerted on foods which are likely to be oxidized.

1. Nutritionally enriched maple syrup, which is enriched in vitamins.

2. Nutritionally enriched maple syrup according to claim 1, which contains vitamin C in an amount of 50 mg or more based on 100 ml of maple syrup obtained by thermally concentrating a maple sap.

3. Nutritionally enriched maple syrup according to claim 2, which is maple syrup having a sugar content of 8 to 70 Brix obtained by thermal concentration.
